(19) United States
(12) Patent Application Publication
(10) Pub. No.: US 2022/0117193 A1
(43) Pub. Date: Apr. 21, 2022

(54) Systems, Devices, and/or Methods for Feeding Animals

(71) Applicant: Harold Long, Hanna, OK (US)

(72) Inventor: Harold Long, Hanna, OK (US)

(21) Appl. No.: 17/504,048

(22) Filed: Oct. 18, 2021

Related U.S. Application Data
(60) Provisional application No. 63/093,197, filed on Oct. 17, 2020.

(51) Int. Cl. A01K 5/02

(52) U.S. Cl. CPC A01K 5/0225; A01K 5/0275

(57) ABSTRACT

Certain exemplary embodiments can provide an animal feeder, which can comprise a storage bin, a plurality of support legs, a trough, a plurality of spikes, a center post, a feed chute, a valve, a sensor, and/or a trough base. The storage bin is constructed to hold animal feed. The plurality of spikes is coupled to animal feeder such that the plurality of spikes protrudes from the animal feeder in proximity to the trough.

### CROSS-REFERENCES TO RELATED APPLICATIONS

This application claims priority to, and incorporates by reference herein in its entirety, pending U.S. Provisional Patent Application Ser. No. 63/093,197 (Attorney Docket No. 1482-01), filed Oct. 17, 2020.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a photograph of a perspective view of an exemplary embodiment of an animal feeder 1000;

FIG. 2 is a photograph of a perspective view of animal feeder 1000;

FIG. 3 is a photograph of a perspective view of animal feeder 1000;

FIG. 4 is a photograph of a perspective view of animal feeder 1000;

FIG. 5 is a photograph of a perspective view of animal feeder 1000;

FIG. 6 is a photograph of a perspective view of animal feeder 1000;

FIG. 7 is a photograph of a perspective view of animal feeder 1000;

FIG. 8 is a photograph of a perspective view of animal feeder 1000;

FIG. 9 is a photograph of a perspective view of animal feeder 1000;

FIG. 10 is a photograph of a perspective view of animal feeder 1000;

FIG. 11 is a block diagram of an exemplary embodiment of a system 11000;

FIG. 12 is a block diagram of an exemplary embodiment of a system 12000;

FIG. 13 is a block diagram of an exemplary embodiment of a system 13000;

FIG. 14 is a block diagram of an exemplary embodiment of a system 14000;

FIG. 15 is a block diagram of an exemplary embodiment of a system 15000;

FIG. 16 is a photograph of a perspective view of an exemplary embodiment of a system 16000;

FIG. 17 is a photograph of a perspective view of an exemplary embodiment of a system 17000;

FIG. 18 is a photograph of a perspective view of an exemplary embodiment of a system 18000;

FIG. 19 is a photograph of a perspective view of an exemplary embodiment of a system 19000;

FIG. 20 is a photograph of a perspective view of an exemplary embodiment of a system 20000;

FIG. 21 is a photograph of a perspective view of an exemplary embodiment of a system 21000; and

FIG. 22 is a photograph of a perspective view of an exemplary embodiment of a system 22000.

### DETAILED DESCRIPTION

Certain exemplary embodiments can provide an animal feeder, which can comprise a storage bin, a plurality of support legs, a trough, a plurality of spikes, a center post, a feed chute, a valve, a sensor, and/or a trough base. The storage bin is constructed to hold animal feed. The plurality of spikes is coupled to animal feeder such that the plurality of spikes protrudes from the animal feeder in proximity to the trough.

Certain exemplary embodiments provide an animal feeder that is constructed to allow desired animals (e.g., deer) to eat without difficulty. The animal feeder comprises a trough that is at least partially surrounded by spikes. The trough is of a size and shape that allows desired animals (e.g., deer) to eat, while the spikes prevent undesired animals (e.g., pigs and hogs) from accessing the trough or eating the food held in the trough.

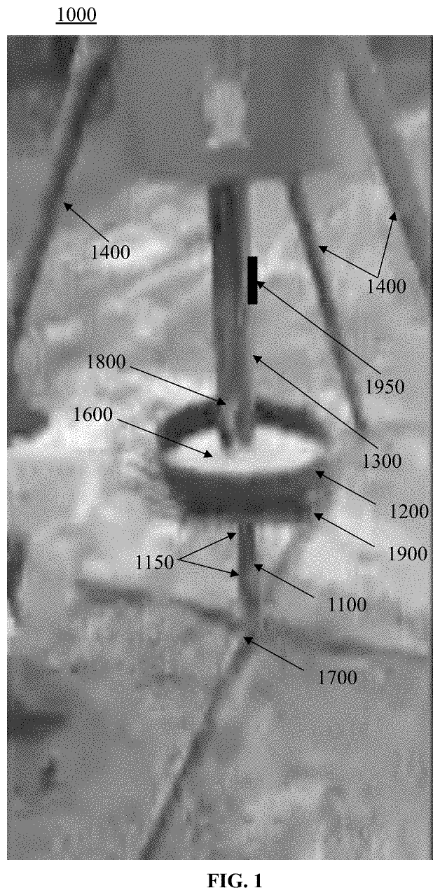

FIG. 1 is a photograph of a perspective view of an exemplary embodiment of an animal feeder 1000, which comprises a center post 1100, a trough 1200, a feed chute 1300, plurality of support legs 1400, and a storage bin 1500.

Food for desired animals (e.g., corn for deer) can be placed in storage bin 1500. A user and/or a sensor 1950 coupled to a dispenser can cause food 1600 to be meted out from storage bin 1500 to trough 1200 via feed chute 1300. In certain exemplary embodiments, a level of food 1600 in trough 1200 can be monitored via a sensor and/or controlled via the sensor causing a valve 1800 to open and/or shut. Feed chute 1300 is open such that animals can eat food 1600.

An elevation of trough 1200 can be set and/or varied via setting a height of center post 1100. Center post 1100 can be constructed with concentric tubes such that center post 1100 can be telescopically extended or collapsed in order to vary an elevation of trough 1200 relative to the ground 1700.

Plurality of support legs 1400 provide support for storage bin 1500 and resist movement or tipping over of animal feeder 1000 from a set position.

Animal feeder 1000 comprises a plurality of spikes 1900. Plurality of spikes 1900 is constructed to prevent undesired small animals (e.g., pigs, hogs, and/or peccaries) from accessing food 1600 in trough 1200. Undesired small animals trying to reach food 1600 in trough 1200 will feel one or more of plurality of spikes 1900 poking skin on their heads or bodies. Pain from being poked by one or more of plurality of spikes 1900 causes undesired small animals to depart and seek food elsewhere.

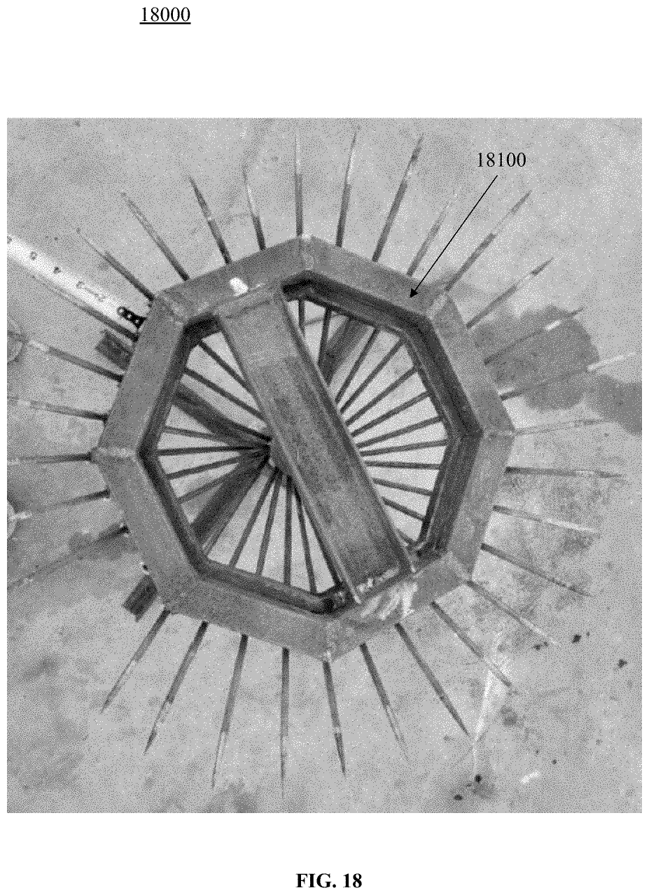

Certain exemplary embodiments comprise:
storage bin 1500, storage bin 1500 constructed to hold animal feed;
plurality of support legs 1400, plurality of support legs 1400 coupled to storage bin 1500;
trough 1200;
plurality of spikes 1900, plurality of spikes 1900 coupled to animal feeder 1000 such that plurality of spikes 1900 protrudes from animal feeder 1000 in proximity to trough 1200;
center post 1100, center post 1100 coupled to trough 1200 and storage bin 1500, plurality of spikes 1900 can be coupled to center post 1100;
feed chute 1300, feed chute 1300 constructed to transfer animal feed from storage bin 1500 to trough 1200;
valve 1800, valve 1800 constructed to control a flow of animal feed from storage bin 1500;
a sensor 1950, sensor 1950 constructed to cause food to be meted out from storage bin 1500 to trough 1200 via valve 1800; and/or
a trough base (see, e.g., trough base 18100 of FIG. 18), wherein trough 1200 is placed upon the trough base, plurality of spikes 1900 can be coupled to the trough base.

In certain exemplary embodiments, plurality of spikes 1900 can comprise spikes with pointed ends extending below trough 1200. In certain exemplary embodiments, plurality of spikes 1900 can comprise spikes with points extending radially around trough 1200. In certain exemplary embodiments, one or more of plurality of spikes 1900 can comprise a pair of pointed ends.

In certain exemplary embodiments, an elevation of animal feeder 1000 is adjustable.

In certain exemplary embodiments, trough 1200 has a round cross section. In certain exemplary embodiments, trough 1200 has an octagonal cross section. In certain exemplary embodiments, trough 1200 has a cross section of a polygon.

In certain exemplary embodiments, center post 1100 comprises concentric tubes 1150. An elevation of animal feeder 1000 can be adjustable via the concentric tubes.

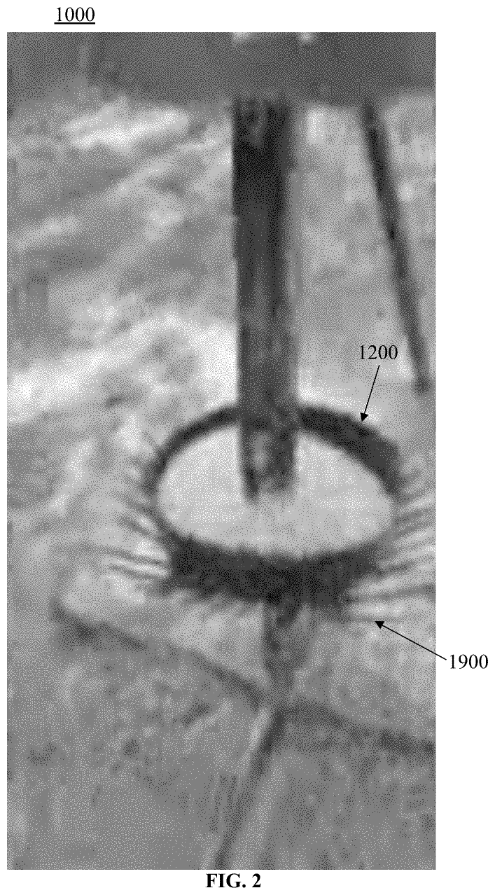

FIG. 2 is a photograph of a perspective view of animal feeder 1000, which illustrates a closer view of trough 1200 and set of spikes 1900 compared to FIG. 1.

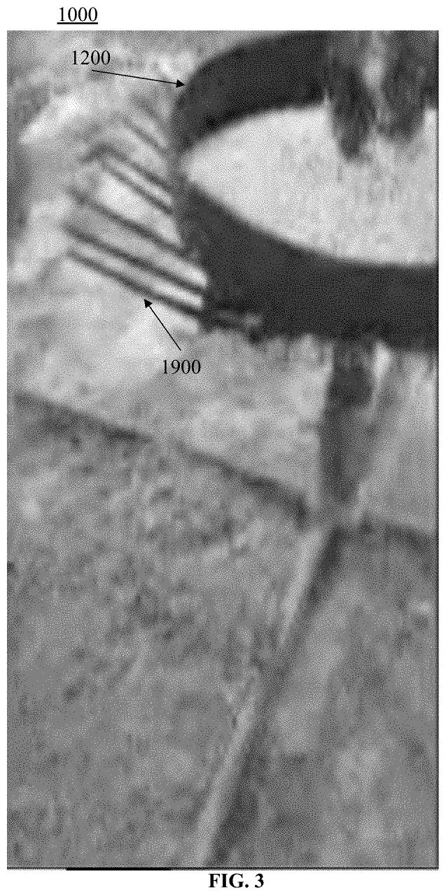

FIG. 3 is a photograph of a perspective view of animal feeder 1000, which illustrates a closer view of trough 1200 and set of spikes 1900 compared to FIG. 1 or FIG. 2.

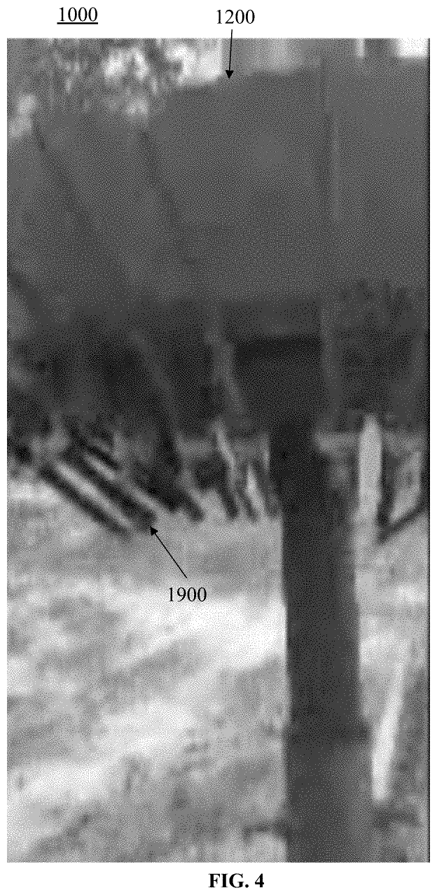

FIG. 4 is a photograph of a perspective view of animal feeder 1000, which illustrates a close-up view of a different perspective of trough 1200 and set of spikes 1900 compared to FIG. 1.

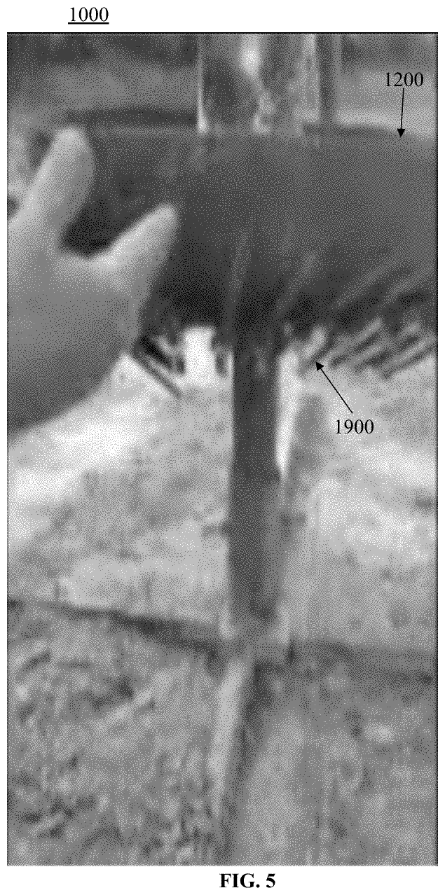

FIG. 5 is a photograph of a perspective view of animal feeder 1000, which illustrates a close-up view of a different perspective of trough 1200 and set of spikes 1900 compared to FIG. 1.

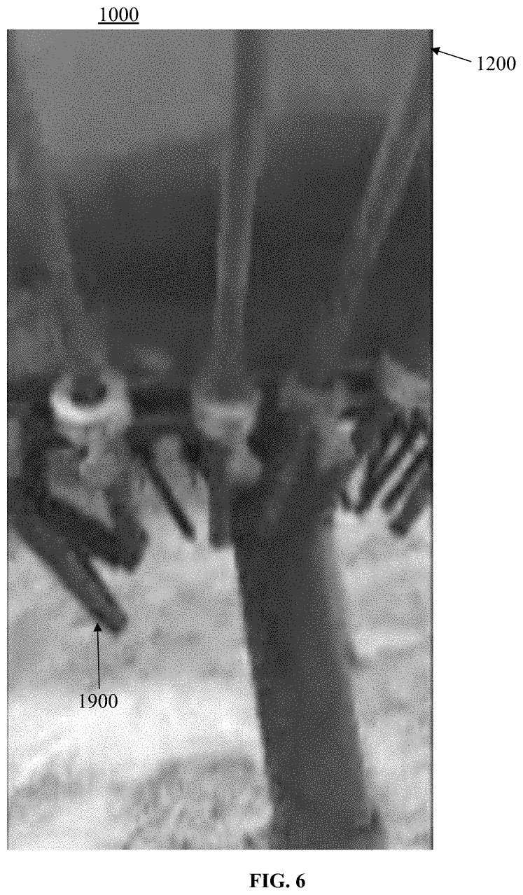

FIG. 6 is a photograph of a perspective view of animal feeder 1000, which illustrates a close-up view of a different perspective of trough 1200 and set of spikes 1900 compared to FIG. 1.

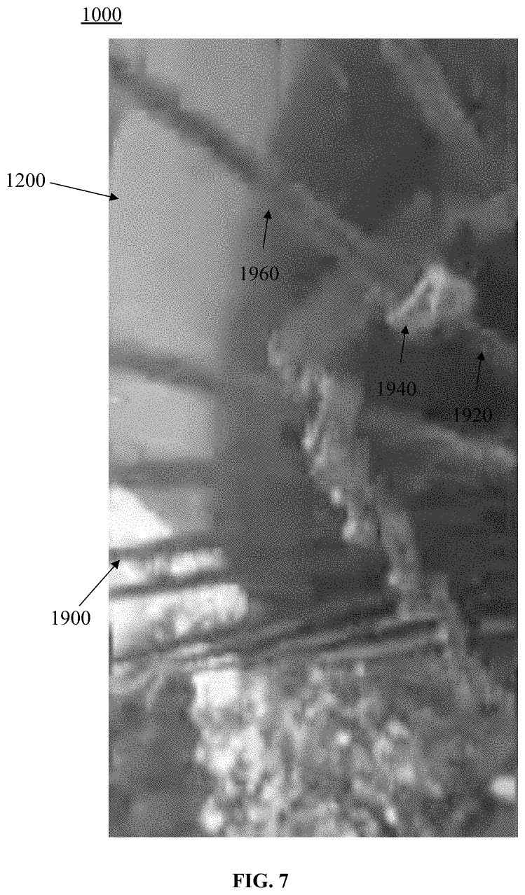

FIG. 7 is a photograph of a perspective view of animal feeder 1000, which illustrates a close-up view of a different perspective of trough 1200 and set of spikes 1900 compared to FIG. 1. As illustrated, each spike of set of spikes 1900 comprises a spike base 1920, a spike coupler 1940, and a spike end 1960. Spike base 1920 can be fixedly coupled to trough 1200 (e.g., via a weldment). A length of each of set of spikes 1900 can be set and/or varied via installing spike end 1960 of given predetermined length(s).

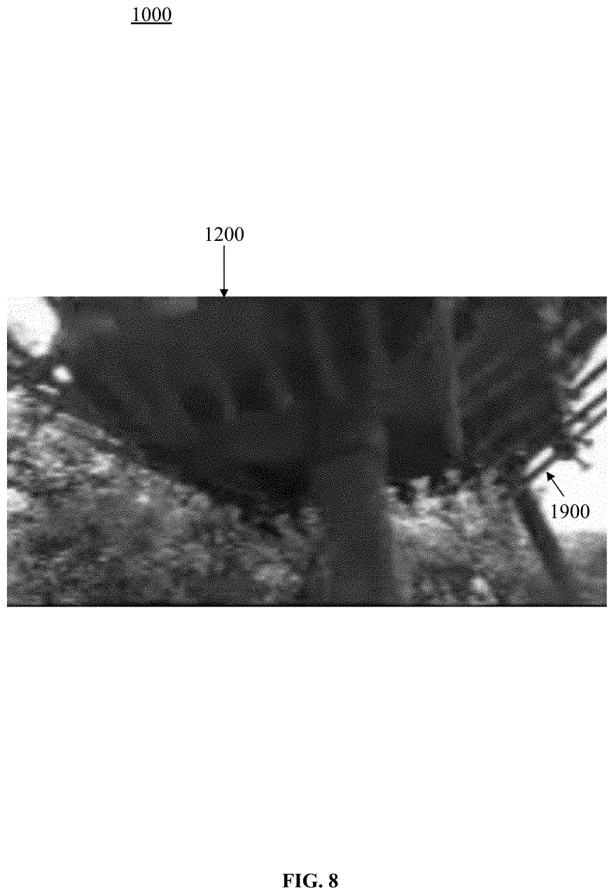

FIG. 8 is a photograph of a perspective view of animal feeder 1000, which illustrates a close-up view of a different perspective of trough 1200 and set of spikes 1900 compared to FIG. 1.

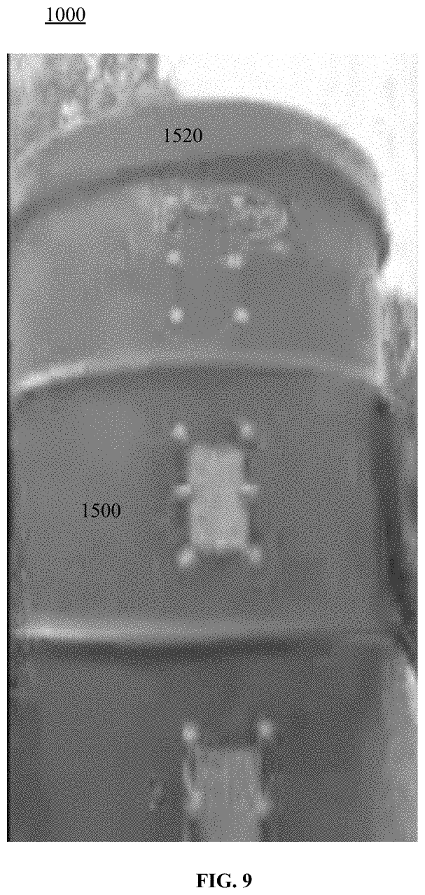

FIG. 9 is a photograph of a perspective view of animal feeder 1000, which illustrates a close-up view of a different perspective of storage bin 1500. Food 1600 can be added to storage bin 1500 via removal of lid 1520. Lid 1520 can prevent food 1600 in storage bin 1500 from getting wet.

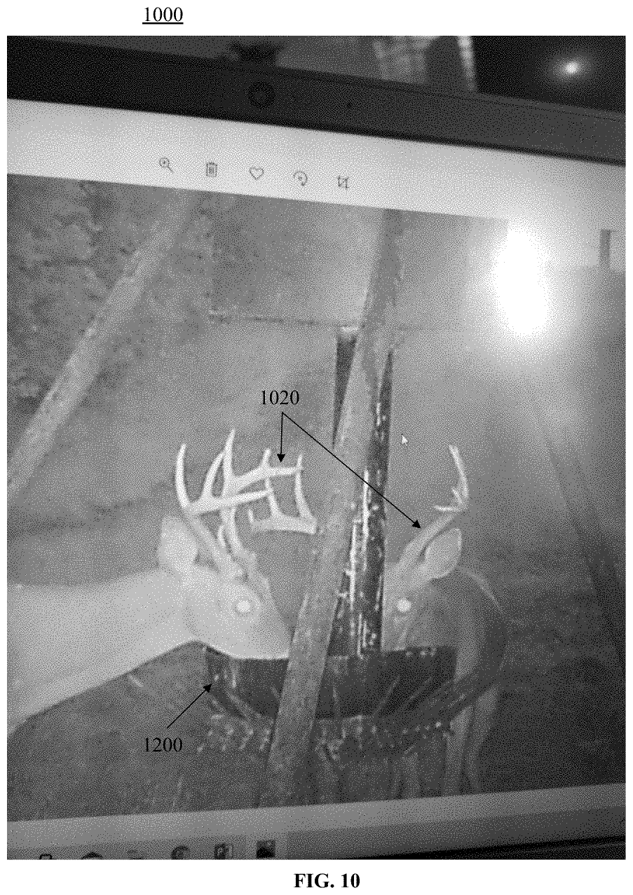

FIG. 10 is a photograph of a perspective view of animal feeder 1000, which illustrates deer 1020 feeding from trough 1200.

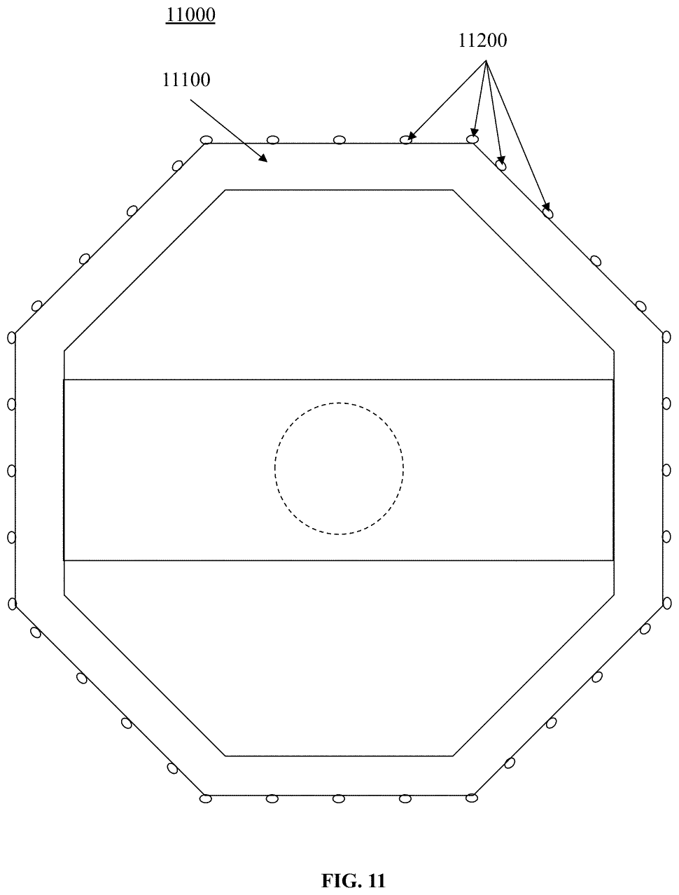

FIG. 11 is a block diagram of an exemplary embodiment of a system 11000, which comprises a trough base 11100 with a plurality of collars 11200. Each of collars 11200 can be coupled to a spike. Spikes provide a barrier for certain small animals to access feed placed upon trough base 11100. In certain exemplary embodiments, trough base 11100 can comprise square tubing (e.g., having a nominal size of one inch or 1½ inches.

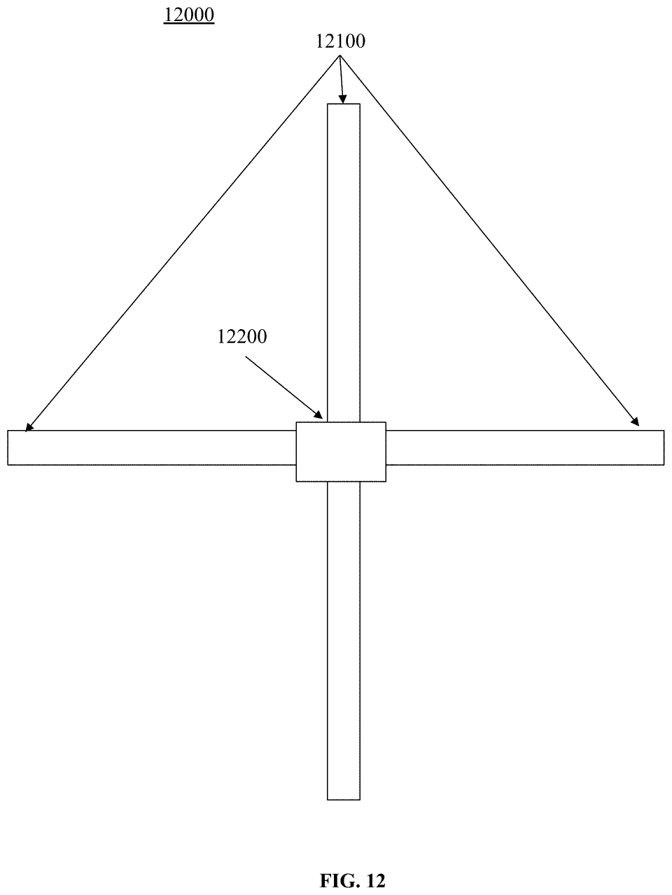

FIG. 12 is a block diagram of an exemplary embodiment of a system 12000, which comprises a plurality of feet 12100. Each of plurality of feet 12100 is coupled via a coupler 12200. In certain exemplary embodiments, coupler 12200 can be made from a nominal three-inch channel.

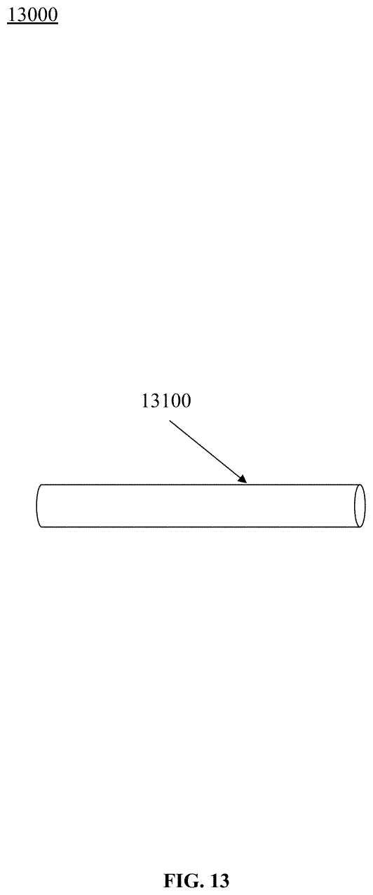

FIG. 13 is a block diagram of an exemplary embodiment of a system 13000, which comprises a pipe 13100. Pipe 13100 can be used as a center post for an animal feeder, such as animal feeder 1000 of FIG. 1. In certain exemplary embodiments, pipe 13100 can be a pipe having a nominal diameter of 2⅜ inches.

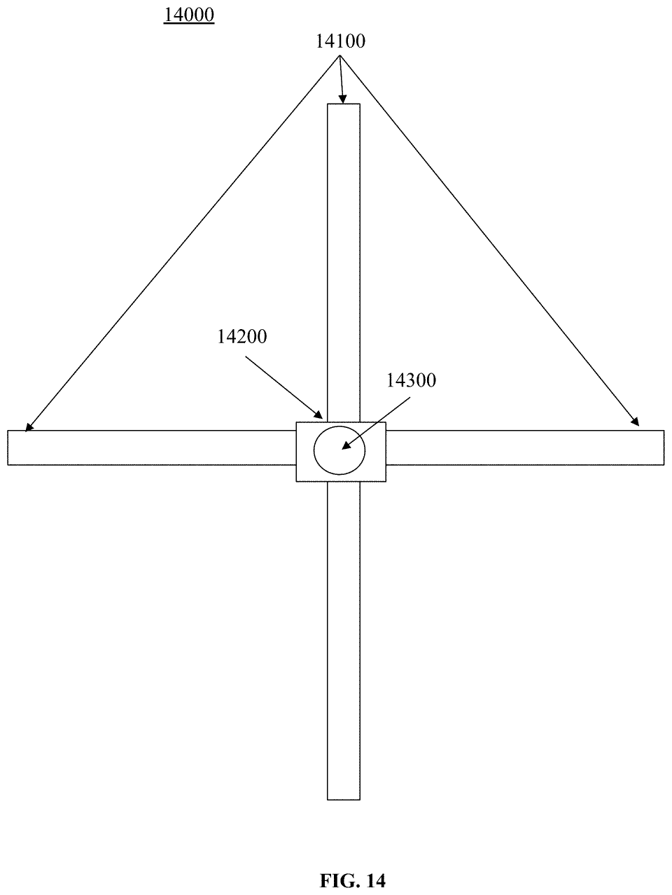

FIG. 14 is a block diagram of an exemplary embodiment of a system 14000, which comprises a plurality of feet 14100. Each of plurality of feet 14100 is coupled via a coupler 14200. Coupler 14200 is coupled to a center post 14300, which can be utilized as a center post for an animal feeder, such as animal feeder 1000 of FIG. 1. In certain exemplary embodiments, center post 14300 can be fabricated from nominal 2⅞ inch pipe.

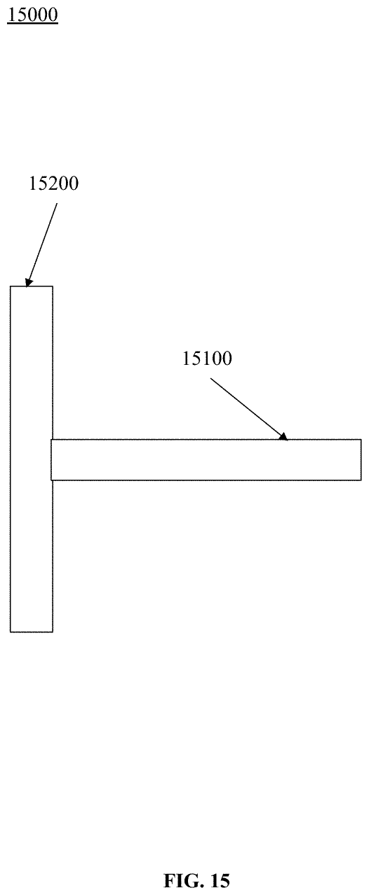

FIG. 15 is a block diagram of an exemplary embodiment of a system 15000, which comprises a center post 15100 and a channel 15200. In certain exemplary embodiments, channel 15200 can be a nominal three-inch channel.

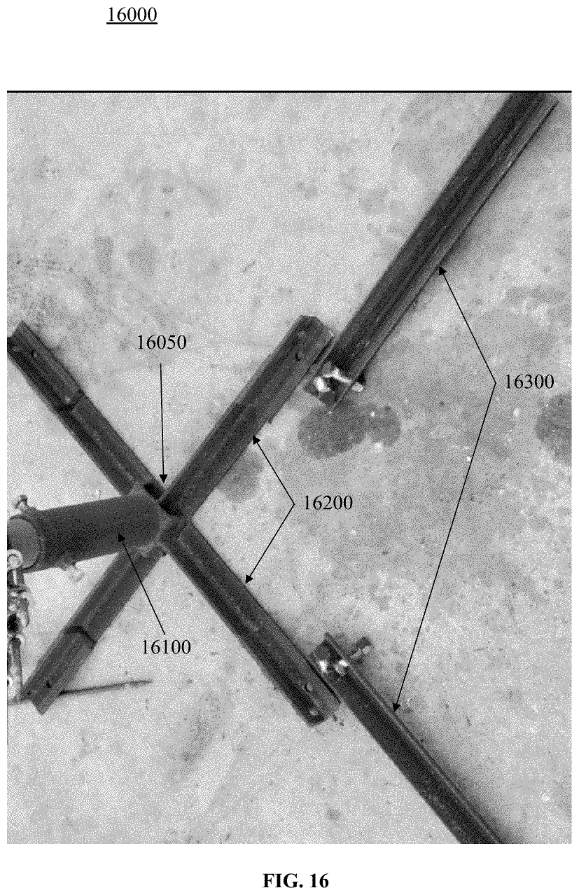

FIG. 16 is a photograph of a perspective view of an exemplary embodiment of a system 16000, which comprises a support base 16050, a center post 16100 and a plurality of feet 16200. As illustrated, plurality of feet 16200 can be made from angle iron. Each of plurality of feet 16200 can be coupled to a foot extender 16300 for improved stability.

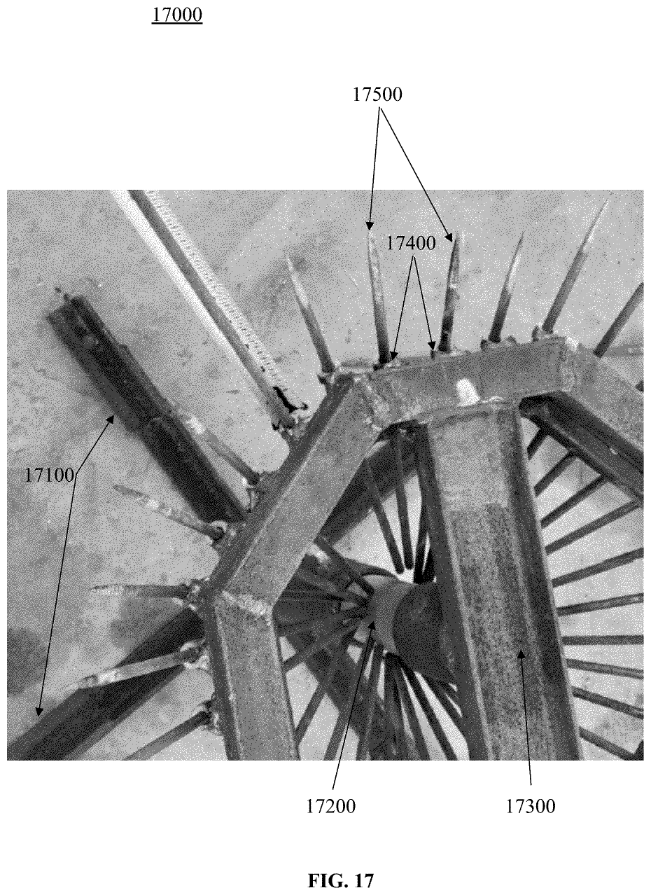

FIG. 17 is a photograph of a perspective view of an exemplary embodiment of a system 17000, which comprises a plurality of feet 17100, a center post 17200, a trough base 17300, and a plurality of spikes 17500. As illustrated, center post 17200 can comprise concentric pipes, which allow center post 17200 to be adjusted in height. As illustrated, plurality of spikes 17500 are coupled to system 17000 via a plurality of collars 17400.

FIG. 18 is a photograph of a perspective view of an exemplary embodiment of a system 18000, which comprises a trough base 18100.

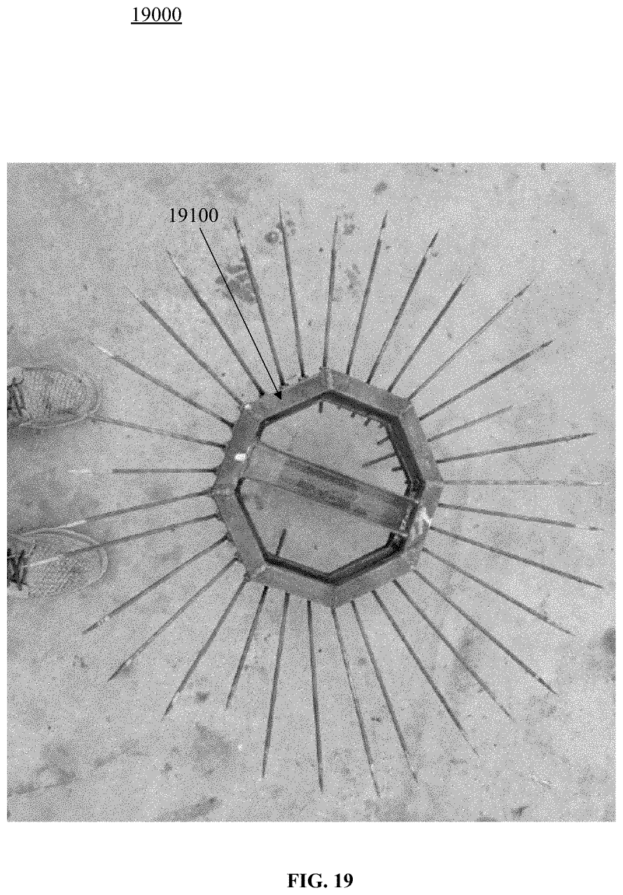

FIG. 19 is a photograph of a perspective view of an exemplary embodiment of a system 19000, which comprises a trough base 9100.

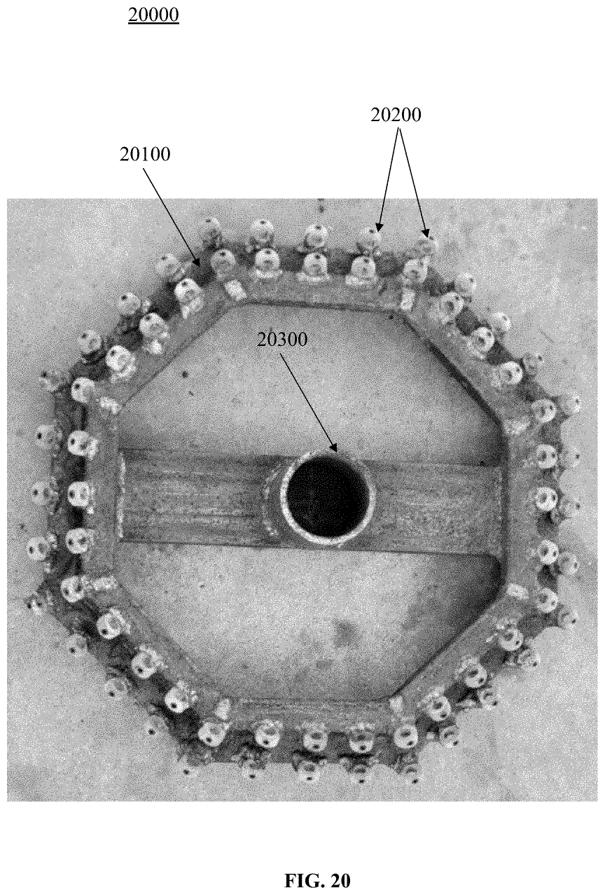

FIG. 20 is a photograph of a perspective view of an exemplary embodiment of a system 20000, which comprises a trough base 20100 and a plurality of collars 20200. Each of plurality of collars 20200 can be coupled to a spike of a plurality of spikes. Trough base 20100 can be coupled to a center post via a sleeve 20300.

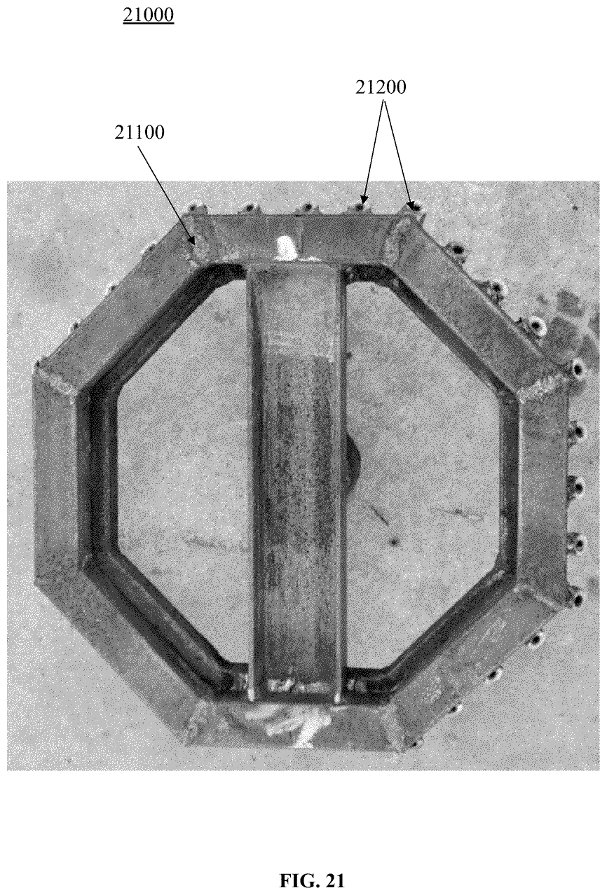

FIG. 21 is a photograph of a perspective view of an exemplary embodiment of a system 21000, which comprises a trough base 21100 and a plurality of collars 21200. Each of plurality of collars 21200 can be coupled to a spike of a plurality of spikes.

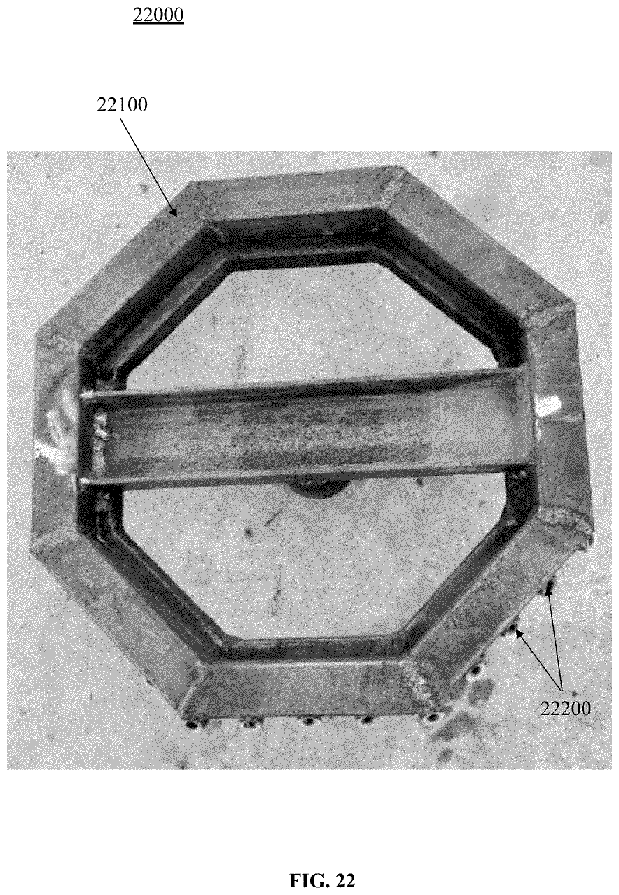

FIG. 22 is a photograph of a perspective view of an exemplary embodiment of a system 22000, which comprises a trough base 22100 and a plurality of collars 22200. Each of plurality of collars 22200 can be coupled to a spike of a plurality of spikes.

Certain exemplary embodiments can provide an animal feeder (see, e.g., animal feeder 1000 of FIG. 1), which can comprise:
a support base (see, e.g., support base 16050 of FIG. 16), the support base comprising a plurality of feet (see, e.g., plurality of feet 16200 of FIG. 16);
a trough base (see, e.g., trough base 18100 of FIG. 18);
a trough (see, e.g., trough 1200 of FIG. 1), the trough coupled to the trough base;
a center post (see, e.g., center post 1100 of FIG. 1), the center post coupled to the support base and the trough base; and
a plurality of spikes (see, e.g., plurality of spikes 1900 of FIG. 1), the plurality of spikes coupled to the animal feeder such that the plurality of spikes protrudes from the animal feeder in proximity to the trough.

In certain exemplary embodiments, the plurality of spikes are coupled to the center post. In certain exemplary embodiments, the plurality of spikes are coupled to the trough base.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adapter—a device used to effect operative compatibility between different parts of one or more pieces of an apparatus or system.
adjust—to change to a sought state.
adjustable—capable of being changed to a sought state.
and/or—either in conjunction with or in alternative to.
animal—any member of the kingdom Animalia, comprising multicellular organisms that have a well-defined shape and usually limited growth, can move voluntarily, actively acquire food and digest it internally, and have sensory and nervous systems that allow them to respond rapidly to stimuli.
apparatus—an appliance or device for a particular purpose.
associate—to join, connect together, and/or relate.
base—a supporting portion of something.
below—lower relative to a surface of the earth.
can—is capable of, in at least some embodiments.
center—a middle point of an object that is approximately equidistant from points on a surface of the object.
cause—to bring about.
chute—a passage down or through which something passes.
comprising—including but not limited to.
concentric—having the same center.
configure—to make suitable or fit for a specific use or situation.
connect—to join or fasten together.
constructed to—made to and/or designed to.
control—to regulate.
convert—to transform, adapt, and/or change.
couple—to physically join in some fashion.
coupleable—capable of being joined, connected, and/or linked together.
define—to establish the outline, form, or structure of
device—a machine, manufacture, and/or collection thereof.
elevation—a distance above a surface of the earth.
extend—to continue in a specified direction.
feed—(n) food (v) to supply food.
feeder—a device that delivers food.
flow—a movement of a substance from one location to another.
hold—to contain something.
install—to connect or set in position and prepare for use.
leg—a supporting member.
may—is allowed and/or permitted to, in at least some embodiments.
mete—to give out by measure.
method—a process, procedure, and/or collection of related activities for accomplishing something.
octagonal—a polygon having eight sides.
pair—a set of two.
partially—to a limited extent.
place—to put something in a predetermined location.
plurality—the state of being plural and/or more than one.
point—a sharp terminal end of something.
polygon—a closed plane figure bounded by straight lines.
post—a piece fixed in an upright position that acts as a support.
predetermined—established in advance.
protrude—to extend beyond a surface.
provide—to furnish, supply, give, and/or make available.
proximity—close to something.
radially—located around a circumference of a circle.
receive—to get, take, acquire, and/or obtain.
round—comprising a curved surface.
sensor—a device used to measure a physical quantity (e.g., temperature, pressure, capacitance, and/or loudness, etc.) and convert that physical quantity into a signal of some kind (e.g., voltage, current, power, etc.).
set—a related plurality.
spike—a projecting rod or bar with at least one pointed end.
storage bin—a tank that holds something for retention.
store—to place, hold, and/or retain.
substantially—to a great extent or degree.
support—to bear the weight of, especially from below.
surround—to enclose around over half a perimeter of an object.
system—a collection of mechanisms, devices, machines, articles of manufacture, processes, data, and/or instructions, the collection designed to perform one or more specific functions.
transfer—to change from one location to another.
transmit—to send, provide, furnish, and/or supply.
trough—a receptacle constructed to hold animal food and from which animals eat.
tube—an elongate member having a longitudinal axis and defining a longitudinal cross-section resembling any closed shape such as, for example, a circle, a non-circle such as an oval (which generally can include a shape that is substantially in the form of an obround, ellipse, limaçon, cardioid, cartesian oval, and/or Cassini oval, etc.), and/or a polygon such as a triangle, rectangle, square, hexagon, the shape of the letter “D”, the shape of the letter “P”, etc. Thus, a right circular cylinder is one form of a tube, an elliptic cylinder is another form of a tube having an elliptical longitudinal cross-section, and a generalized cylinder is yet another form of a tube.
upon—on a surface of.
valve—a device by which a flow of a substance is started, stopped, and/or regulated by a movable part that opens, shuts, or partially obstructs one or more ports or passageways.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. An animal feeder comprising:
a storage bin, the storage bin constructed to hold animal feed;
a plurality of support legs, the plurality of support legs coupled to the storage bin;
a trough;
a plurality of spikes, the plurality of spikes coupled to the animal feeder such that the plurality of spikes protrudes from the animal feeder in proximity to the trough;
a center post, the center post coupled to the trough and the storage bin; and
a feed chute, the feed chute constructed to transfer animal feed from the storage bin to the trough.

2. The animal feeder of claim 1, further comprising:
a valve, the valve constructed to control a flow of animal feed from the storage bin; and
a sensor, the sensor constructed to cause food to be meted out from the storage bin to the trough via the valve.

3. The animal feeder of claim 1, further comprising:
a trough base, wherein the trough is placed upon the trough base.

4. The animal feeder of claim 1, further comprising:
a trough base, wherein:
the trough is placed upon the trough base; and
the plurality of spikes are coupled to the trough base.

5. The animal feeder of claim 1, wherein:
the plurality of spikes comprises spikes with pointed ends extending below the trough.

6. The animal feeder of claim 1, wherein:
the plurality of spikes comprises spikes with points extending radially around the trough.

7. The animal feeder of claim 1, wherein:
each of the plurality of spikes comprises a pair of pointed ends.

8. The animal feeder of claim 1, wherein:
an elevation of the animal feeder is adjustable.

9. The animal feeder of claim 1, wherein:
the trough has a round cross section.

10. The animal feeder of claim 1, wherein:
the trough has an octagonal cross section.

11. The animal feeder of claim 1, wherein:
the trough has a cross section of a polygon.

12. The animal feeder of claim 1, wherein:
the center post comprises concentric tubes, an elevation of the animal feeder adjustable via the concentric tubes.

13. An animal feeder comprising:
a support base, the support base comprising a plurality of feet;
a trough base;
a trough, the trough coupled to the trough base;
a center post, the center post coupled to the support base and the trough base; and
a plurality of spikes, the plurality of spikes coupled to the animal feeder such that the plurality of spikes protrudes from the animal feeder in proximity to the trough.

14. The animal feeder of claim 13, wherein:
the plurality of spikes are coupled to the center post.

15. The animal feeder of claim 13, wherein:
the plurality of spikes are coupled to the trough base.
